(19) United States
(12) Patent Application Publication
(10) Pub. No.: US 2023/0062242 A1
(43) Pub. Date: Mar. 2, 2023

(54) Procedure and System for Profile Generation

(71) Applicant: Jochen Wild, Mainz-Kostheim (DE)

(72) Inventor: Jochen Wild, Mainz-Kostheim (DE)

(21) Appl. No.: 17/895,297

(22) Filed: Aug. 25, 2022

Related U.S. Application Data
(63) Continuation of application No. PCT/IB2021/051592, filed on Feb. 26, 2021.

(30) Foreign Application Priority Data
Feb. 26, 2020 (DE) 102020104958.7
Jul. 31, 2020 (DE) 102020120359.4

(51) Int. Cl. F16D 1/10

(52) U.S. Cl. CPC F16D 1/10; F16D 2001/103

(57) ABSTRACT

The present invention relates to a method for the profile generation of involute-based toothed shaft connections, comprising: determination of a circle described by the reference diameter d_{B′}, distance-based generation of the shaft top circle using the reference diameter distance A_{dB}, the shaft top circle being the quasi first element of the shaft profile; distance-based generation the hub top circle using the effective touching height h_{w}, distance-based determination of the touching point between the shaft tooth flank and the shaft root fillet using the shaft form oversize of the reference profile C_{FP1} or the shaft form oversize C_{FP1} generation of the shaft root fillet, the shaft reference profile being already completely generated by means of this step in the case of full filleting of the shaft; constant-tangent generation of the shaft root circle for shaft root filleting, this step being required only in the case of partial filleting; and obtainment of the shaft profile.

The present invention relates to a procedure and a system for profile generation of involute splined shaft connections.

### BRIEF FORMULATION OF THE TECHNICAL FIELD OF THE INVENTION

A frequent problem in drive technology is the transmission of dynamic and often abruptly occurring torsional moments from a shaft to a hub or vice versa. Profile shaft connections are generally particularly suitable for this purpose. As a result of their production-related economic advantages, involute splined toothed shaft connections according to [DIN 5480] are currently widely used for the requirements mentioned at the beginning of this paragraph. They represent the state of the art. [Wild 20]

### OVERVIEW ABOUT THE CURRENT STATE OF THE ART

Involute splined shaft connections according to [DIN 5480] are defined by their system for generating the reference profile. This is listed together with other system-relevant variables in Table 3 of the first part of the corresponding standard. Because of its relevance to the present application, the content of this table is presented and explained hereafter. The basis for this is the so-called reference profile, cf. FIG. 1. [Wild 20]

Over all reference diameters d_{B} standardized in the [DIN 5480], the module m varies between 0.5 mm and 10 mm with correspondingly defined reference points, cf. equation (1). However, the definition range is further restricted depending on the reference diameter d_{B}. For example, for the smallest reference diameter d_{B} of 6 mm, a definition range of the module m of 0.5 mm to 0.8 mm is defined. For the largest reference diameter d_{B}, modules m of 6 mm to 10 mm are defined. For larger reference diameters d_{B}, the definition range thus shifts towards larger modules m. For the number of modules m per reference diameter d_{B} it is valid that it tends to increase starting from the smallest reference diameter d_{B} of 6 mm to 13 mm and then decreases again. [Wild 20]

$$m = \{ \begin{matrix}\begin{matrix}0 , 5 & 0 , 6 ; & 0 , 75 ; & 0 , 8 ; & 1 , 0 ; & 1 , 25 ; & …\end{matrix} \\ \begin{matrix}… & 1 , 5 ; & 1 , 75 ; & 2 ; & 2 , 5 ; & 3 ; & 4 ; & 5 , & 6 , & 8 ; & 10\end{matrix}\end{matrix} \} \qquad ( 1 ) [ DIN 5480 ]$$

With the justification given in the [DIN 5480], that the flank angles α of 37.5° as well as 45° are included in the [ISO 4156], the [DIN 5480] is restricted to a flank angle α of 30°, cf. equation (2). However, it is already emphasized in the preface of the [DIN 5480] that toothed shaft connections according to the previously stated standards are not modular, i.e. their connection partners cannot be exchanged for each other. The reason given for this is that the system for generating reference profiles of involute splined shaft connections of the [ISO 4156] is based on module series, whereas that of the [DIN 5480] is based on stepped reference diameters d_{B} defined independently of the module m. [Wild 20]

α=30° (2) [DIN 5480]

The pitch p is calculated according to equation (3), which is generally known in the field of gearing. [Wild 20]

p=m·π (3)

A special feature of the [DIN 5480] is that the profile shift is used in analogy to running splines. Although the principle of operation is the same, the motivation for the application is different. Thus, the profile shift is not used to adjust the center distance and tooth shape by distributing it accordingly between the two contact partners of a gear stage. Rather, it is used to put the shaft tip diameter dₐ₁ in a fixed relation to the reference diameter d_{B}. This is explained below in more detail. [Wild 20]

As already mentioned above, the [DIN 5480] is based on stepped reference diameters d_{B}. These correspond to the inner diameters of rolling bearings. From the overall objective of the system for reference profile generation of involute splined shaft connections according to the [DIN 5480], that the mounting of rolling bearings across the toothing of the shaft must always be possible, it results that the shaft tip diameter dₐ₁ is calculated from the reference diameter d_{B} by its reduction in amount. In this relation, with reference to FIG. 2, it can be derived from the equations (20), (21) as well as (25) that the shaft tip diameter dₐ₁ is always smaller by 20% of the module m than the reference diameter d_{B}. [Wild 20]

With a selected reference diameter d_{B} and a module m, in fact the shaft tip diameter dₐ₁ is determined, cf. FIG. 2, but the numbers of teeth z and the shift factors x are still freely selectable. Thus, a clear geometrical determination is not yet possible. This is quasi first given by the definition of a value range for the profile shift factors x, cf. conditions (5) and (7). The corresponding validity interval is selected in a way, that it corresponds to exactly one tooth. This ensures that at least one number of teeth z always exists, in exceptional cases a maximum of two numbers of teeth z, which fulfills the boundary conditions. [Wild 20]

z₁=z₁ (4) [DIN 5480]

−0.05≤x₁≤+0.45 (Exceptions until +0.879) (5) [DIN 5480]

In analogy to the [DIN 3960], for ring gears negative signs are introduced for the hub number of teeth z₂ as well as for the hub profile shift factor x₂. So the equations (4) and (5) result in the equations (6) and (7). [Wild 20]

z₂=−Z₁ (6) [DIN 5480]

x₂=−x₁→+0.05x₂≥−0.45 (Exceptions until −0.879) (7) [DIN 5480]

In contrary to the [DIN 3960], the tip heights of the reference profile h_{aP} are not set equal to the module m, but are defined according to equation (8). Consequently, they are 55% smaller. [Wild 20]

h_{aP}=0.45·m (8) [DIN 5480]

The root heights of the reference profile h_{fP} are defined in dependence on the manufacturing process, cf. equations (9) to (12). [Wild 20]

h_{fP}=0.55·m (Broaching) (9) [DIN 5480]

h_{fP}=0.60·m (Gear hobbing) (10) [DIN 5480]

h_{fP}=0.65·m (Gear shaping) (11) [DIN 5480]

h_{fP}=0.84·m (Cold rolling) (12) [DIN 5480]

The tip heights of the tool reference profile h_{aP0} are set equal to the root heights of the reference profile h_{fP}, cf. equation (13). [Wild 20]

h_{aP0}=h_{fP} (13) [DIN 5480]

The tooth heights of the reference profile result thus each as the sum of the tip height of the reference profile h_{aP} and the root height of the reference profile h_{fP}, cf. equation (14). [Wild 20]

h_{P}=h_{aP}+h_{fP} (14) [DIN 5480]

The tip clearances of the reference profile c_{P} each result as the difference between the root height of the reference profile h_{fP} and the tip height of the reference profile h_{aP}. They thus describe the design space which is available for the connection partner specific form excess of the reference profile c_{FP} as well as for the root rounding radius ρ_{fP}. [Wild 20]

c_{P}=h_{fP}−h_{aP} (15) [DIN 5480]

The root rounding radii of the reference profile ρ_{fP} result in dependence of the manufacturing process as a fixum according to the equations (16) and (17). A free variation is thus not foreseen. [Wild 20]

ρ_{fP}=0.16·m (Chipping) (16) [DIN 5480]

ρ_{fP}=0.54·m (Cold rolling) (17) [DIN 5480]

The pitch circle diameter d is calculated according to equation (18), which is generally known in the field of gearing. [Wild 20]

d=m·z (18)

The base circle diameter d_{b}, i.e. that circle, at which the involute begins, which is also generally known in the field of gearing, is calculated according to equation (19). [Wild 20]

d_{b}=m·z·cos α (19)

The profile shift amounts x·m describe the connection partner specific sign-corrected distance between the profile reference line and the pitch circle. They are derived below on the basis of FIG. 2 for the example of the shaft, cf. equation (20). [Wild 20]

2·x₁·m=d_{B}−2·0.1·m−2·h_{aP}−d (20) [DIN 5480]

Equation (20) leads to equation (21). With it, in consideration of inequality (5), the shaft profile shift factor x₁ as well as the corresponding shaft number of teeth z₁ (in exceptions, in each case in plural) can be determined. [Wild 20]

d_{B}=·m·z₁+2·x₁·m+1.1·m, Diameter with standard numbers according to the [DIN 323] and rolling bearing bore diameter, in the range d_{B}<40 mm and m≤1.75 mm integer stepped with 1 mm. (21) [DIN 5480]

Based on FIG. 1, equation (22) can be derived to calculate the hub tip circle diameter dₐ₂. [Wild 20]

dₐ₂=m·z₂+2·x₂·m+0.9·m (22) [DIN 5480]

To estimate the hub root circle diameter d_{f2}, in the [DIN 5480] equation (23), which is generally known in the field of gearing, is used as a basis. In it, through the root height of the reference profile h_{fP}, of which the tip clearance of the reference profile c_{P} is a component, design space is provided for the form excess of the reference profile c_{FP} as well as the root rounding radius of the reference profile ρ_{fP}, but this only with at least empirical character. With reference to FIG. 6, all previously named parameters are to be understood as hub-specific ones. [Wild 20]

d_{f2}=m·z₂+2·x₂·m−2h_{fP} (see 7.1 [DIN 5480]) (23)

The hub root form circle diameter d_{Ff2} can be determined with inequality (24). [Wild 20]

d_{Ff2}≤−(dₐ₁+2·c_{Fmin}) (24) [DIN 5480]

For determination of the shaft tip diameter dₐ₁ equation (25) is given. The validity of this equation can be comprehended on the basis of FIG. 1. [Wild 20]

dₐ₁=m·z₁+2·x₁·m+0.9·m (25) [DIN 5480]

To estimate the shaft root circle diameter d_{f1}, in the [DIN 5480] the equation (26), which is generally known in the field of gearing, is used as a basis. It has the same structure as the one used to calculate the hub root circle diameter d_{f2}, cf. equation (23), and thus also has the same properties. [Wild 20]

d_{f1}=m·z₁+2·x₁·m−2·h_{fP} (see 7.1 [DIN 5480]) (26)

The shaft root circle diameter d_{Ff1} can be determined with inequality (27). [Wild 20]

d_{Ff1}≤|dₐ₂|−2·c_{Fmin} (27) [DIN 5480]

Depending on the achievable manufacturing quality, the [DIN 5480] offers recommendations for the form excesses of the reference profile c_{FP}, cf. equations (28) to (31). However, these are not part of their system for reference profile generation. [Wild 20]

c_{FP}=0.02·m (Broaching) (28) [DIN 5480]

c_{FP}=0.07·m (Gear hobbing) (29) [DIN 5480]

c_{FP}=0.12·m (Gear shaping) (30) [DIN 5480]

c_{FP}=0.12·m (Cold rolling) (31) [DIN 5480]

The minimum form excess c_{Fmin} is defined in table 4 of the first part of the [DIN 5480]. [Wild 20]

c_{Fmin} see table 4 [DIN 5480] (32) [DIN 5480]

The nominal hub tooth gap e₂ corresponds to the nominal shaft tooth thickness s₁, cf. equation (33). [Wild 20]

e₂=s₁ (33) [DIN 5480]

The nominal shaft tooth thickness s₁ is to be calculated according to equation (34), which is generally known in the field of gearing. [Wild 20]

s₁=m·π/2+2·x₁·m·tan α (34)

Criticism of the state of the art and derivation of a problem definition

The system for generation of reference profiles of involute splined shaft connections according to the [DIN 5480] presented in the overview of the relevant state of the art does not describe the geometric relationships of such connections in a completely mathematically closed manner. While the tip circle diameters dₐ are described exactly, the root circle diameters d_{f} are calculated starting from the tip circle diameters dₐ with empirical elements. These are part of the root heights of the reference profile h_{fP}. The empirical parts of the root heights of the reference profile h_{fP} are defined in the [DIN 5480] as tip clearances of the reference profile c_{P}. They can be calculated alternatively to the definition given in the corresponding named standard by subtracting the correlating head-root-circle pairing. With the tip clearances of the reference profile c_{P}, geometric areas for the root rounding radii of the reference profile ρ_{fP} and the form excesses of the reference profile c_{FP} are implemented in the system for generation of reference profiles of involute splined shaft connections according to the [DIN 5480] in a blanket manner, i.e. without taking the corresponding quantities parametrically into account. Consequently, for given tip and root circles, the root roundings are made without concrete attention to the geometric relationships. The profile excesses of the reference profile c_{FP} are thus resulting or redundant dimensions. The previously described fact can be traced with FIG. 1 on the reference profile, better however with FIG. 3 on the nominal profile. [Wild 20]

In the previous paragraph it was claimed that in the [DIN 5480] with the tip clearances of the reference profile c_{P} geometric areas for the root rounding radii of the reference profile ρ_{fP} and the form excesses of the reference profile c_{FP} are defined in a blanket manner, without directly considering the corresponding parameters. This is proven in the following. First of all, it should be noted that according to the [DIN 5480], no differentiation between the shaft and the hub is provided either for the root heights of the reference profile h_{fP} nor for the tip clearances of the reference profile c_{P}, cf. FIG. 1. It is only distinguished according to the manufacturing process used. As the connection partners are usually produced in different ways, a differentiation in analogy to other parameter definitions is meaningful. A corresponding determination is made with FIG. 6. It is already considered in the following. [Wild 20]

Connection partner specific the equations (35) and (36) result for the tip clearances of the reference profile c_{P} in mathematical formulation. [Wild 20]

c_{P1}=−dₐ₂−d_{f1}=−0.9·m+2·h_{fP1} (35) [Wild 20]

c_{P2}=−d_{f2}−dₐ₁=2·h_{fP2}−0.9·m (36) [Wild 20]

Considering the root heights of the reference profile h_{fP} defined in the [DIN 5480] in accordance with the manufacturing process, cf. equations (9) to (12), the equations (37) to (40) are derived from the equations (35) and (36) for the determination of the tip clearances of the reference profile c_{P} in accordance with the manufacturing process and the connection partner. [Wild 20]

c_{P}=0.2·m (Broaching) (37) [Wild 20]

c_{P}=0.3·m (Gear hobbing) (38) [Wild 20]

c_{P}=0.4·m (Gear shaping) (39) [Wild 20]

c_{P}=0.78·m (Cold rolling) (40) [Wild 20]

With the equations (37) to (40) it is shown that the distances between the tip and the root circles, into which the root rounding radii of the reference profile ρ_{fP} and the form excesses of the reference profile c_{FP} need to be fitted specific for the shaft and the hub, are not dependent on these parameters. Thus, due to the empirical character of the [DIN 5480], a free variation of the previously mentioned parameters can only be possible if they have been included in the coefficients of the equations (37) to (40) in a suitable manner. This is not the case. Resulted yet in the course of numerical preliminary investigations for [Wild 20] that even at connections without parameter variation, i.e. in absolute compliance with the [DIN 5480], geometrical anomalies can occur. Thus, with reference to FIG. 3, geometrical penetration between the shaft and the hub can arise if the contact point of the involute and the circle used for the root rounding is located above the hub tip circle radius rₐ₂ respectively in the contact area of the shaft and the hub. On the other hand, a tangent discontinuity in the tooth root area can result if the contact point of the circle used for the root rounding and the root circle is located beyond the tooth segment. Finally, it should be emphasized that the flank angle α, as well as already the root rounding radii of the reference profile ρ_{fP} and the form excesses of the reference profile c_{FP}, are not included in general form in the system for profile generation of involute splined shaft connections according to the [DIN 5480]. Consequently, it is to be expected that a variation of this parameter beyond the restriction normatively given in this context, cf. equation (2), also quickly leads to geometric anomalies. [Wild 20]

As described in the overview about the current state of the art, a special feature of the [DIN 5480] is that the shaft tip circle diameter dₐ₁ is defined as the shaft outer diameter in the manner that rolling bearings can be mounted across the toothing of the shaft. This is realized by the fact that the reference diameter d_{B} is equal to the rolling bearing inner diameter and the shaft tip diameter dₐ₁ is always slightly smaller due to profile shift, cf. equation (25). In this respect, it can be derived with the equations of the system for profile generation of involute splined shaft connections according to the [DIN 5480] that the shaft tip diameter dₐ₁ is always smaller than the reference diameter d_{B} by 0.2 times of the module m, cf. FIG. 2. Thus, the module m takes influence on the nominal clearance between the rolling bearing inner diameter and the shaft outer diameter. Depending on the manufacturing process, this definition as well as its fixed implementation may be useful. However, there are also cases where other specifications are advantageous. Hence, the possibility to freely vary the shaft tip diameter dₐ₁ in relation to the reference diameter d_{B} is aspirational. This also applies to the effective contact height h_{w}. [Wild 20]

In various publications, cf. among others [Maiw 08] and in particular [DFG ZI 1161], it is stated, that with complex trochoidal connections significantly higher shape stabilities can be realized than with the currently often in practice used and established involute splined shaft connections according to the [DIN 5480]. Taking this fact as an occasion, the aim of the research project [FVA 742 I] was to clarify experimentally and numerically how large the expected load capacity advantages are. The basis for this was a firmly defined scenario. For a given envelope diameter of 25 mm, the respective optima should be compared. The result is that the optimal complex trochoid has an appreciably higher shape stability than its counterpart of the [DIN 5480]. However, it needs to be emphasized that in [FVA 742 I] the shape stabilities of significantly different geometries were compared with each other. Differences to the disadvantage of the toothed shaft connections according to the [DIN 5480], which can be judged at the latest with the results given in [Wild 20], existed in detail with the geometrical influencing variables shaft root circle radius r_{f1}, shaft root rounding radius ρ_{f1}, flank angle α as well as shaft tip circle radius rₐ₁, see FIG. 4. It should be emphasized at this point that, due to the system for profile generation of involute splined shaft connections according to the [DIN 5480], it is not possible to generate a better geometrical match between the profile shaft connections compared in [FVA 742 I], cf. FIG. 4. [Wild 20]

From the previously presented criticism of the systematic and, as a consequence, of the system for the generation of reference profiles of involute splined shaft connections according to [DIN 5480], the problem on which the invention is based was derived. This consisted in the development of a new systematic for the profile generation of such connections. In addition, a system for nominal geometry generation of involute splined shaft connections was to be derived in a mathematically closed manner, considering corresponding technical requirements. This request served to realize parametric full access to all parameters determining the geometry of the profile shape and the associated possibility for requirement-specific geometric alignment of connections. With reference to FIG. 4, it was also intended to develop new functionalities in order to make further load capacity potentials usable. [Wild 20]

The above described problem is solved in a first aspect of the present invention by a procedure for profile generation of involute splined shaft connections, comprising the steps
a) determination of a circle described by the reference diameter d_{B},
b) distance-based generation of the shaft tip circle using the reference diameter distance A_{dB}, whereby the shaft tip circle represents the quasi first element of the shaft profile,
   whereby starting from the shaft tip circle in steps c), d) and e), the shaft profile generation is sequentially unidirectional inward,
c) distance-based generation of the hub tip circle using the effective contact height h_{w},
d) distance-based determination of the contact point between the shaft tooth flank and the shaft root rounding using the shaft form excess of the reference profile c_{FP1} or the shaft form excess c_{F1},
e) generation of the shaft root rounding, whereby in the case of a shaft full rounding, the shaft reference profile is already completely generated with this step,
f) tangential generation of the shaft root circle to the shaft root rounding, whereby this step is only required for partial rounding, and
g) obtain the shaft profile.

The inventive procedure is equally valid for reference profiles as well as nominal profiles. It allows, in particular, the mathematically closed formulation of the previously named profile shapes. By the procedure according to the invention, as well as by the system according to the invention, which is described in more detail below, now parametric full access on all the parameters determining the geometry of the corresponding profile shape and, accompanying this, the requirement-specific geometric connection alignment is possible. [Wild 20]

In a preferred embodiment of the procedure according to the invention, this further comprises, based on the shaft profile, the steps of
h) generation of the hub tip circle as the first element of the hub profile, whereby, starting from the shaft tip circle in steps i), j) and k), the hub profile generation is performed sequentially unidirectionally outward,
i) distance-based determination of the contact point between the hub tooth flank and the hub root rounding using the hub form excess of the reference profile c_{FP2} or the hub form excess c_{F2},
j) generation of the hub root rounding, whereby in the case of a hub full rounding, the hub profile is already completely generated with this step,
k) tangential generation of the hub root circle to the hub root rounding, whereby this step is only required for partial rounding, and
l) obtain the hub profile.

As a result of the correlation between the shaft and the hub, the generation of the hub tip circle as an element of the hub profile is part of the shaft profile generation, i.e. of steps a) to g). Thus, the hub profile is built on the shaft profile. The systematic for generating the other elements of the hub profile is as described above, see steps h) to l).

In further embodiments, the procedure according to the invention allows the free choice of the following parameters:
reference diameter d_{B},
module m,
flank angle α,
root roundings ρ_{f},
form excesses c_{F},
effective contact height without profile modification h_{w}(R_{hw}=0).

In a second aspect, the present invention relates to a system for profile generation of involute splined shaft connections consisting of a shaft and hub as defined in the originally filed claim 8, the text of which is referred to herein in its entirety.

With the inventive system for profile generation of involute splined shaft connections, in particular for nominal geometry generation, cf. (Tab. 2, Tab. 3), due to the given possibility for free variation of all the parameters determining the nominal geometry, geometric alignment of the connections originating from it to the requirements specified for them is henceforth possible.

A third aspect of the present invention relates to the newly developed parameter of the reference diameter distance A_{dB}, with which the function for free selection of the distance between the reference diameter d_{B} and the shaft tip circle diameter dₐ₁ is implemented in the system according to claim 8.

Finally, the fourth aspect of the present invention relates to the use of the inventive system as shown in claim 8 for profile modification, where the parameters designated as x_{I1}, x_{I2}, previously x₁, x₂, are known, while the profile modification is based on the factors x_{M1}, x_{M2}, y₁, y₂, R_{hw}, A_{hw} and functionally interacts with the previously designated parameters beyond the profile shift.

If in the description of the inventive system and/or the inventive parameter of the reference diameter distance A_{dB} procedure features are named, then these refer in particular to the inventive procedure. Likewise, the objective characteristics, which are given in the description of the inventive procedure, refer to the system device (100) and/or the inventive parameter of the reference diameter distance A_{dB}.

### BRIEF DESCRIPTION OF THE INVENTION FOR PROBLEM SOLVING

Remedy regarding the critique points of the system for profile generation of involute splined shaft connections according to the [DIN 5480] given in the section Criticism of the state of the art and derivation of a problem definition is not possible by its adjustment. Rather, the development of a fundamentally another systematic is required. Among other things, this was accomplished in [Wild 20]. The basis for this is that the toothed shaft connection is generated from the reference diameter d_{B} connection partner specific sequentially unidirectionally, cf. FIG. 5. This is explained below in more detail for the in comparison to the hub more complex case of the shaft with partial rounding based on the nominal geometry. Starting from the reference diameter d_{B}, the shaft tip circle diameter dₐ₁ is determined. For this purpose, only the parameter reference diameter distance A_{dB} is used. The shaft tip circle diameter dₐ₁ is consequently independent of the shaft profile shift factor x₁. With reference to the newly developed inventive function of the profile modification, cf. FIG. 13 with FIG. 14, this is absolutely necessary. Further, the hub tip circle diameter dₐ₂ is obtained by profile shift. Starting from this, the contact point between the involute and the circle K₁ used for the shaft root rounding is defined by the shaft form excess c_{F1}. Considering a tangential transition between the involute of the flank of the profile shaft and the circle K₁ used for the shaft root rounding as well as between the circle K₁ used for the shaft root rounding and the shaft root circle, a user defined shaft root rounding radius ρ_{f1} results in a shaft root circle radius r_{f1} as a redundant dimension. In opposite to the system for profile generation of involute splined shaft connections according to the [DIN 5480], it is thus dependent on all the profile shape determining parameters without any empirical components. This is also evident from a cross comparison between FIG. 3 and FIG. 5. The previously on the example of the shaft explained new systematic for the profile generation of involute splined shaft connections is the basis for the further development of the system for the nominal geometry generation of involute splined shaft connections, cf. (Tab. 2, Tab. 3), by its concrete mathematical formulation. [Wild 20]

The feature of the [DIN 5480] described in the section Criticism of the state of the art and derivation of a problem definition, that the shaft tip circle diameter dₐ₁ is always slightly smaller than the rolling bearing inner diameter, is defined in a generally valid manner and is functionally developed further in the inventive system for the generation of the nominal geometry of involute splined shaft connections, see (Tab. 2, Tab. 3). In this relation, the reference diameter d_{B} is still base diameter. However, it is essential that the shaft tip circle diameter dₐ₁ is not defined in dependence on the shaft profile shift factor x₁. With reference to the developed inventive function of the profile modification, cf. FIG. 13 with FIG. 14, this is absolutely necessary. The correlation between the shaft tip circle diameter dₐ₁ and the reference diameter d_{B} is now established via the new inventive parameter reference diameter distance A_{dB}, which, as its name already implies, defines their distance. The characteristics of this quantity is equal to that of the profile shift. The reference diameter distance A_{dB} thus is radially effective. Furthermore, a negative value causes a reduction of the shaft tip circle diameter dₐ₁. For the parameter constants but also equations can be applied. Mathematically, the insertion of positive values for the inventive parameter reference diameter distance A_{dB} is also possible. From a technical point of view, however, this is generally not sensible. Would this mean that the shaft tip circle diameter dₐ₁ is larger than the reference diameter d_{B}. [Wild 20].

Furthermore, it should be emphasized that the profile shift factors x are no longer influencing factors for the calculation of all tip and root circles. Directly, only the hub profile shift factor x₂ is still used to determine the hub tip circle diameter dₐ₂. This furthermore indirectly takes influence on the shaft root circle diameter d_{f1}. The shaft tip circle diameter dₐ₁ as well as the hub root circle diameter d_{f1} are completely independent of the profile shift factors x. Due to the modified procedure for determining the geometry, it is now possible to use the profile shift factors x to influence the hub tip and the shaft root circle, but without changing the shaft tip and the hub root circle. Thus, this influencing variable is now usable for the so-called profile modification, cf. FIG. 13 with FIG. 14. [Wild 20]

Shaft-related, a positive shaft profile shift factor x₁ means that the tool is shifted to the outside. As a result, the shaft root circle and, in addition, the shaft tooth thickness as well as the hub tooth gap increase. Thus, the maximum realizable shaft root radius ρ_{f1} does not change respectively does not change significantly. However, under the aspect of shape stability, this is often aspirable. In order to be able to influence the maximum realizable shaft root rounding radius ρ_{f1}, the shaft tooth thickness has to be changed. This needs to be reduced proportionately. This can be realized by introducing the so-called profile modification factors y. In its function, the position of the tools used for gear cutting is not changed, but the tools are modified by selective change (machining) in their depth of engagement. The use of the profile modification factors y leads, aside the increase of the absolute value of the hub tip circle diameter dₐ₂ and associated with it the shaft root circle diameter d_{f1}, to an increase of the shaft tooth gap. Therewith a larger shaft root rounding radius ρ_{f1} is realizable. This is visualized by FIG. 13 with FIG. 14. [Wild 20]

Concluding, it can be stated that the developed profile modification as a component of the inventive system for nominal geometry generation of involute splined shaft connections, cf. (Tab. 2, Tab. 3), comprises two possibilities of modification. Thus, this can be done by using the profile shift factors x, more precisely the modification profile shift factors x_{M}, as well as the profile modification factors y. Moreover, the combination of these sizes is not only possible, but explicitly provided for. Both the profile shift factors x and the profile modification factors y take direct influence on the hub tip circle diameter dₐ₂ and therewith indirectly on the shaft root circle diameter d_{f1}. While the application of the profile shift factors x results in larger hub root rounding radii ρ_{f2} being realizable with nearly unchanged situation regarding the shaft root rounding radii ρ_{f1}, the application of the profile modification factors y has the opposite effect. In practice, both the shaft and the hub, for example in the case of a thin-walled design, can be the weaker connection partner. The motivation for implementing both profile modification options described at the beginning of this paragraph results, among other things, from the goal of case-specific coordination of the degrees of utilization of both connection partners and the associated optimal use of the toothed shaft connection. [Wild 20]

Further objectives, features, advantages and possible applications will be apparent from the following description of embodiments based on the figures, which are not restrictive of the invention. Thereby, all described and/or pictorially depicted features form the subject matter of the invention by themselves or in any combination, also independently of their summary in the claims or their relation back.

### BRIEF DESCRIPTION OF THE DRAWINGS

FIG. 1 is a reference profile according to the [DIN 5480] [Wild 20].

FIG. 2 is a derivation of the profile shift [Wild 20].

FIG. 3 illustrates the geometric relationships of involute splined shaft connections according to the [DIN 5480] in the shaft root area on the example of the connection.

FIG. 4 illustrates the geometric differences of the profile shaft connections compared in the research project [FVA 742 I] (same scale) [Wild 20].

FIG. 5 illustrates basic systematics of the inventive system for profile generation of involute splined shaft connections, cf. (Tab. 2, Tab. 3), on the example of the connection.

FIG. 6 illustrates an adjusted reference profile of the [DIN 5480] [Wild 20].

FIG. 7 illustrates requirement-specific design of toothed shaft connections according to (Tab. 2, Tab. 3) by selecting the reference diameter d_{B} as well as the reference diameter distance A_{dB} [Wild 20].

FIG. 8 illustrates the requirement-specific design of toothed shaft connections according to the inventive system for nominal geometry generation of involute splined shaft connections , cf. (Tab. 2, Tab. 3), by the selection of the module m resp. the shaft number of teeth z₁ on the example of the connection.

FIG. 9 illustrates the requirement-specific design of toothed shaft connections according to the inventive system for nominal geometry generation of involute splined shaft connections by the selection of the flank angle a on the example of the connection.

FIG. 10 illustrates the requirement-specific design of toothed shaft connections according to the inventive system for nominal geometry generation of involute splined shaft connections, cf. (Tab. 2, Tab. 3), by the selection of the root rounding radii ρ_{f} on the example of the connection.

FIG. 11 illustrates the requirement-specific design of toothed shaft connections according to the inventive system for nominal geometry generation of involute splined shaft connections, cf. (Tab. 2, Tab. 3), by the selection of the form excesses c_{F} on the example of the connection.

FIG. 12 illustrates the requirement-specific design of toothed shaft connections according to the inventive system for nominal geometry generation of involute splined shaft connections, cf. (Tab. 2, Tab. 3), by the selection of the effective contact height without profile modification h_{w}(R_{hw}=0) on the example of the connection.

FIG. 13 is a not profile modified toothed shaft connection.

FIG. 14 illustrates a requirement-specific design of toothed shaft connections according to the inventive system for nominal geometry generation of involute splined shaft connections, cf. (Tab. 2, Tab. 3), by the selection of the profile modification controlling parameters R_{hw} as well as A_{hw} on the example of the connection.

### DETAILED DESCRIPTION OF THE INVENTION

For a given occasion, in [Wild 20] based on a newly developed systematic for the profile generation of involute splined shaft connections, a new system for the nominal geometry generation of such connections was developed, cf. (Tab. 2, Tab. 3). The extensive derivations of its equations based on their functional correlation are given in [Wild 20]. The object of the present application is merely the presentation of the developed systematic for profile generation of involute splined shaft connections, cf. the section brief description of the invention for problem solving, of the resulting inventive system for nominal geometry generation of such connections as well as its immediate components. The two last-mentioned aspects will be discussed in the following. [Wild 20]

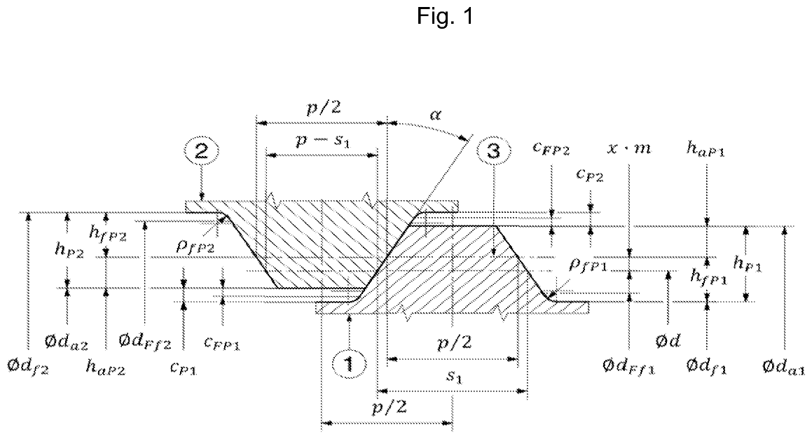

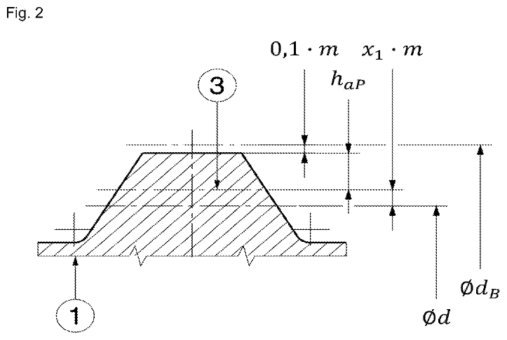

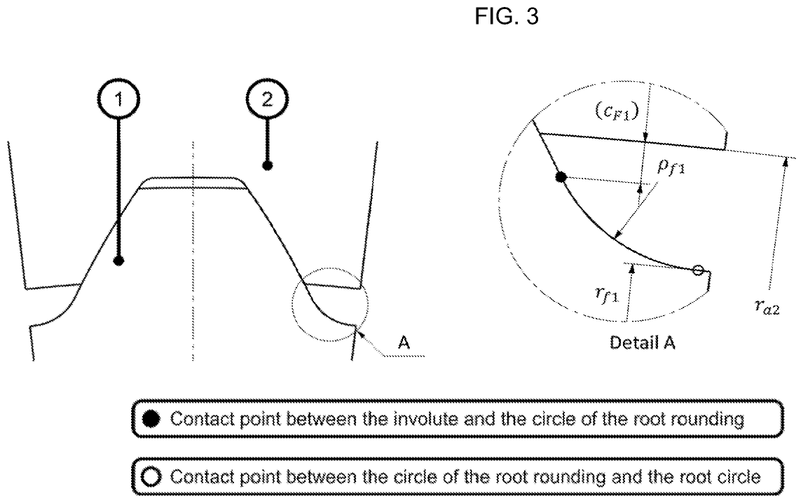

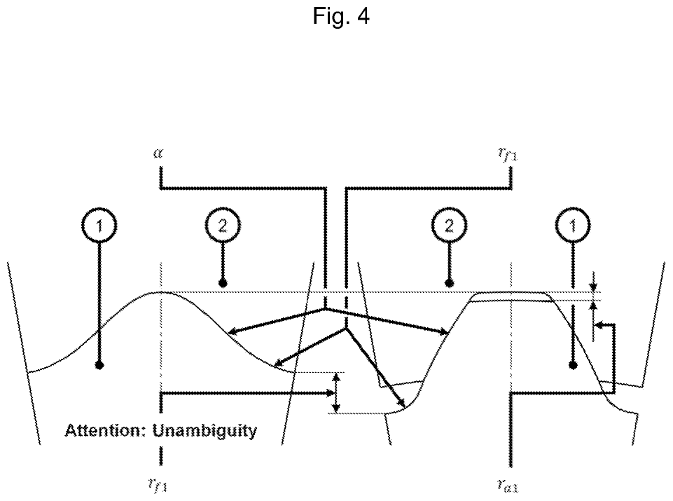

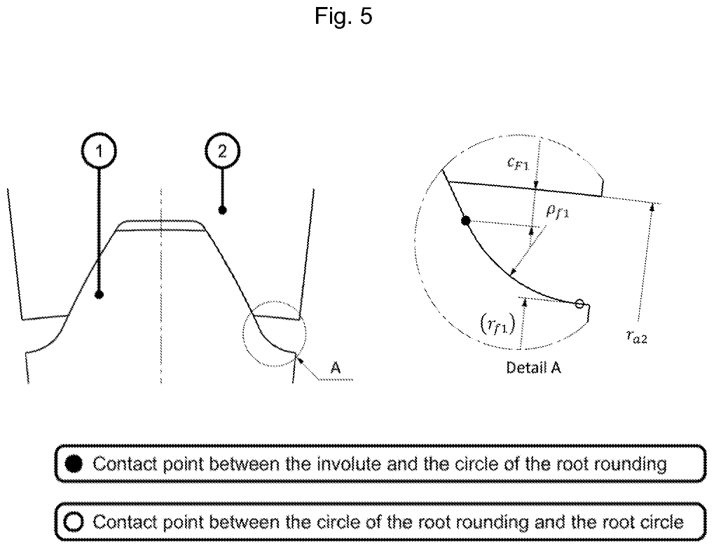

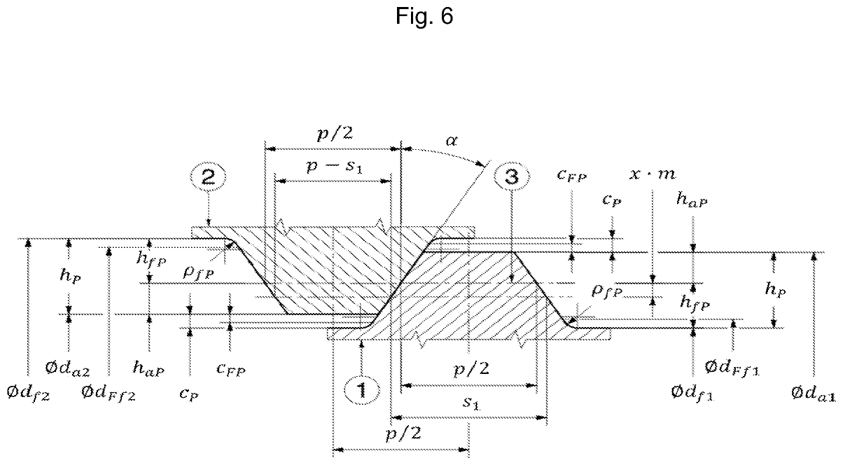

In analogy to the [DIN 5480], the reference profile shown in FIG. 6, revised in comparison to FIG. 1, serves as the basis for the definition of the in [Wild 20] inventive system for the nominal geometry generation of involute splined shaft connections, cf. (Tab. 2, Tab. 3). From a cross-comparison between the figures mentioned above, it is evident that there is now a strict differentiation between shaft- and hub-specific quantities. From the input parameters listed in Tab. 1 of the inventive system for nominal geometry generation of involute splined shaft connections, cf. (Tab. 2, Tab. 3), this concerns the root rounding radii of the reference profile ρ_{fP} as well as the form excesses of the reference profile c_{FP}. [Wild 20]

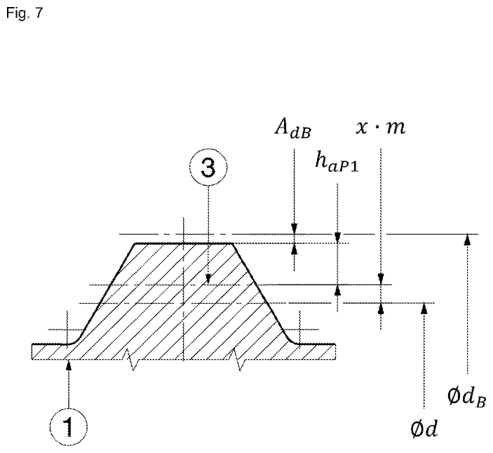

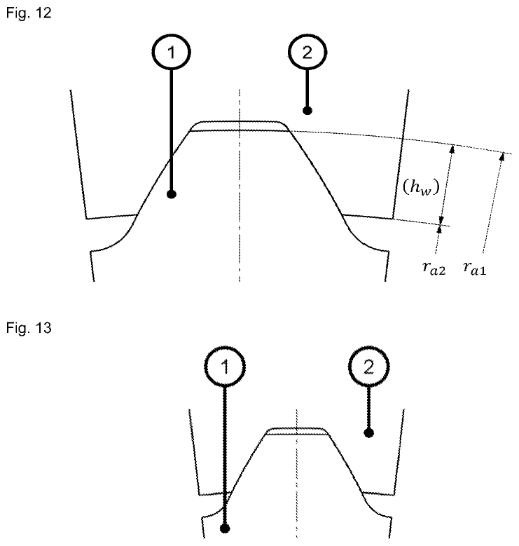

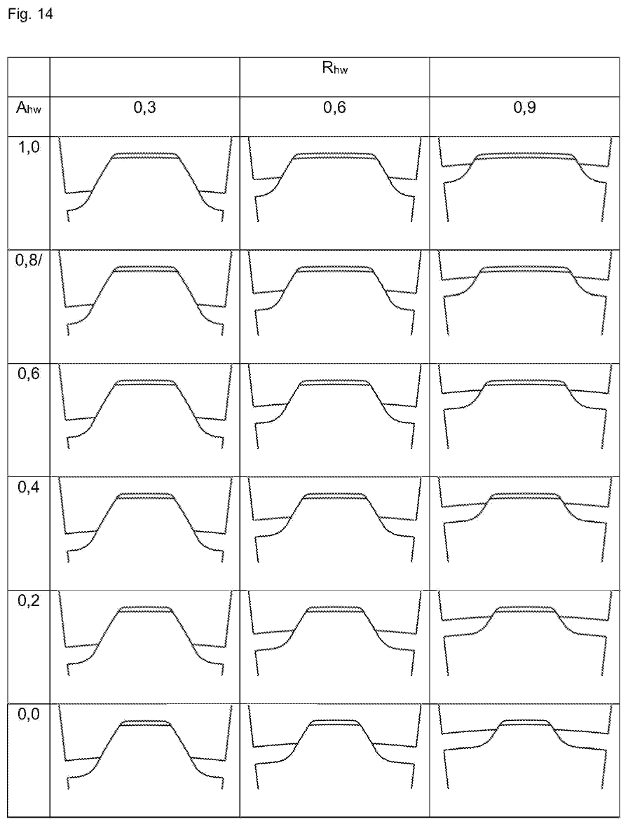

The control of the inventive system for nominal geometry generation of involute splined shaft connections, cf. (Tab. 2, Tab. 3), is performed by the parameters listed in Tab. 1. In this regard, it should be noted that some of them are newly introduced, so their function is not yet commonly known. Concerning this, the reference diameter distance A_{dB}, cf. FIG. 7, the effective contact height of the flanks in radial direction without profile modification h_{w}(R_{hw}=0), cf. FIG. 12, as well as the parameters reduction factor of the effective contact height R_{hw} controlling the profile modification and the distribution key of the reduction of the effective contact height A_{hw}, cf. FIG. 13 with FIG. 14, have to be named. Further, the inventive system for nominal geometry generation of involute splined shaft connections is completely presented in (Tab. 2, Tab. 3). In order of completeness, Tab. 4 provides equations for the calculation of further geometric quantities which are only of a descriptive but not of a determining character regarding the profile shape presented in (Tab. 2, Tab. 3). Their application is therefore optional. In the development of the inventive system for nominal geometry generation of involute splined shaft connections presented in (Tab. 2, Tab. 3), it was considered that connections of the [DIN 5480] are still generatable. The only question here is how the input parameters listed in Table 1 have to be selected so that geometry equivalence results. The corresponding values are summarized in Tab. 5. With reference to the results given in [Wild 20] on the shape stability of involute splined shaft connections according to (Tab. 2, Tab. 3), however, it may also be useful to simply generate geometrically compatible connection partners according to (Tab. 2, Tab. 3) with those according to [DIN 5480]. The values to be selected in this case for the input parameters listed in Table 1 are given in Table 6. [Wild 20]

Definition of the Input Parameters

The control of the inventive system for nominal geometry generation of involute splined shaft connections according to (Tab. 2, Tab. 3) is completely performed by the input parameters summarized in Tab. 1. [Wild 20]

TABLE 1
[Wild 20]

| Symbol | Toothing data and calculation equations |
|---|---|
| d_{B} | Freely selectable |
| A_{dB} | Freely selectable (radial effectiveness) |
| m | Freely selectable |
| z₁ | Freely selectable |
| z₂ | −z₁ |
| α | Freely selectable |
| ρ_{f1} | In the interval 0 ≤ ρ_{f1} ≤ ρ_{f1}^{V} freely selectable |
| ρ_{f2} | In the interval 0 ≤ ρ_{f2} ≤ ρ_{f2}^{V} freely selectable |
| c_{F1} | Freely selectable |
| c_{F2} | Freely selectable |
| h_{w}(R_{hw} = 0) | Freely selectable |
| R_{hw} | In the interval 0 ≤ R_{hw} < 1 freely selectable |
| A_{hw} | In the interval 0 ≤ A_{hw} < 1 freely selectable |

Mathematical Formulation

The inventive system for nominal geometry generation of involute splined shaft connections is fully defined with the equations given in (Tab. 2, Tab. 3). These are compiled in such a way that, with appropriately selected input data, cf. Tab. 1, the equations only need to be applied in sequential order. Only exception in this respect is the calculation of the full rounding radii ρ_{f}^{V}. Here, it is recommended to always determine these before choosing the root rounding radii ρ_{f}, so that the radii chosen by the user are ensured to be smaller than these and thus technically realizable in a feasible way. [Wild 20]

TABLE 2
[Wild 20]

| Symbol | Toothing data and calculation equations |
|---|---|
| d | m · z₁ |
| x_{I1} · m | $\frac{{d}_{B} - d - {h}_{w} ( {R}_{hw} = 0 ) + 2 \cdot {A}_{dB}}{2}$ |
| x_{I2} · m | −x_{I1} · m |
| x_{M1} · m | A_{hw} · R_{hw} · h_{w}(R_{hw} = 0) |
| x_{M2} · m | −x_{M1} · m |
| x₁ · m | (x_{I1} + x_{M1}) · m |
| x₂ · m | −x₁ · m resp. (x_{I2} − x_{M2}) · m |
| y₁ · m | R_{hw} · h_{w}(R_{hw} = 0) · (1 − A_{hw}) |
| y₂ · m | −y₁ · m |
| p | m · π |
| s₁ | $\frac{p}{2} + 2 \cdot {x}_{1} \cdot m \cdot tan α$ |
| αₛ₁ | $\frac{{s}_{1}}{r}$ |
| α_{Er} | $\vert {tan}^{- 1} ( \frac{\sqrt{1 - {cos}^{2} α}}{cos α} ) - \frac{\sqrt{1 - {cos}^{2} α}}{cos α} \vert$ |
| α_{E} | $\frac{{α}_{s 1}}{2} + {α}_{Er}$ |
| α_{S} | $\frac{2 π}{{z}_{1}}$ |

TABLE 3
[Wild 20]

| Symbol | Toothing data and calculation equations |
|---|---|
| d_{b} | d · cos α |
| dₐ₂ | −d + 2 · x₂ · m + h_{w}(R_{hw} = 0) + 2 · y₂ · m |
| u_{E1} | $\sqrt{{( \frac{- {r}_{a 2} - {c}_{F 1}}{{r}_{b}} )}^{2} - 1}$ |
| α_{KM1}^{V} | $( - 1 ) \cdot ( {α}_{E} - \frac{{α}_{S}}{2} )$ |
| ρ_{f1}^{V} | $\frac{{r}_{b} ( \begin{matrix}tan ( {α}_{KM 1}^{V} ) ( cos {u}_{E 1} + {u}_{E 1} sin {u}_{E 1} ) + \\ + sin {u}_{E 1} - {u}_{E 1} cos {u}_{E 1}\end{matrix} )}{cos {u}_{E 1} - tan ( {α}_{KM 1}^{V} ) sin {u}_{E 1}}$ |
| dₐ₁ | d_{B} + 2 · A_{dB} |
| \|\vec{K}_{M1}\| | $\sqrt{\begin{matrix}{( {r}_{b} ( cos {u}_{E 1} + {u}_{E 1} sin {u}_{E 1} ) + {ρ}_{f 1} sin {u}_{E 1} )}^{2} + \\ + {( {r}_{b} ( - sin {u}_{E 1} + {u}_{E 1} cos {u}_{E 1} ) + {ρ}_{f 1} cos {u}_{E 1} )}^{2}\end{matrix}}$ |
| d_{f1} | 2 · (\|\vec{K}_{M1}\|− ρ_{f1}) |
| u_{E2} | $\sqrt{{( \frac{{r}_{a 1} + {c}_{F 2}}{{r}_{b}} )}^{2} - 1}$ |
| α_{KM2}^{V} | (−1) · α_{E} |
| ρ_{f2}^{V} | $\frac{{r}_{b} ( \begin{matrix}tan ( {α}_{KM 2}^{V} ) ( cos {u}_{E 2} + {u}_{E 2} sin {u}_{E 2} ) + \\ + sin {u}_{E 2} - {u}_{E 2} cos {u}_{E 2}\end{matrix} )}{tan ( {α}_{KM 2}^{V} ) sin {u}_{E 2} - cos {u}_{E 2}}$ |
| d_{f2} | (−1) · 2 · (\|\vec{K}_{M2}\| + ρ_{f2}) |
| \|\vec{K}_{M2}\| | $\sqrt{\begin{matrix}{( {r}_{b} ( cos {u}_{E 2} + {u}_{E 2} sin {u}_{E 2} ) - {ρ}_{f 2} sin {u}_{E 2} )}^{2} + \\ + {( {r}_{b} ( - sin {u}_{E 2} + {u}_{E 2} cos {u}_{E 2} ) - {ρ}_{f 2} cos {u}_{E 2} )}^{2}\end{matrix}}$ |

Supplementary, Geometric Parameters

In addition to the parameters listed in (Tab. 1, Tab. 2, Tab. 3), further geometric quantities with a merely descriptive character, i.e. not with an influence on the profile shape according to (Tab. 2, Tab. 3), can be specified. Their calculation is therefore optional. Without claiming to be complete, these are defined in Tab. 4. [Wild 20]

TABLE 4
[Wild 20]

| Symbol | Toothing data and calculation equations |
|---|---|
| c₁ | $\frac{- {d}_{f 1} - {d}_{a 2}}{2}$ |
| c₂ | $\frac{- {d}_{a 1} - {d}_{f 2}}{2}$ |
| d_{Ff2} | −(dₐ₁ + 2 · c_{F2}) |
| d_{Ff1} | −dₐ₂ − 2 · c_{F1} |
| e₂ | s₁ |
| h_{w} | ${h}_{w} = \frac{{d}_{a 1} - \vert {d}_{a 2} \vert}{2}$ |
| h₁ | $\frac{{d}_{a 1} - {d}_{f 1}}{2}$ |
| h₂ | $\frac{- {d}_{f 2} + {d}_{a 2}}{2}$ |

Geometry Equivalence to the [DIN 5480]

In the inventive system for nominal geometry generation of involute splined connections, cf. (Tab. 2, Tab. 3), it is considered that geometrically equivalent connection partners to the [DIN 5480] are generatable. In this context, it is necessary to define how the input parameters listed in Tab. 1 have to be selected so that geometry equivalence between the previously named profile shapes results. The corresponding definitions are given in Table 5. [Wild 20]

TABLE 5
[Wild 20]

| Symbol | Toothing data and calculation equations |
|---|---|
| d_{B} | Select acc. to the [DIN 5480] |
| A_{dB} | −0.1 · m |
| m | Select acc. to the [DIN 5480] |
| x_{I1} | −0.05 ≤ x_{I1} ≤ 0.45 |
| x_{I2} | −x_{I1} |
| z₁ | Select acc. to the [DIN 5480] |
| z₂ | −z₁ |
| α | 30°, cf. [DIN 5480] |
| ρ_{f1} = ρ_{fP1} | Select acc. to the [DIN 5480] |
| ρ_{f2} = ρ_{fP2} | Select acc. to the [DIN 5480] |
| c_{F1} = c_{FP1} | Due to the empirical character of the [DIN 5480], this value has |
| | to be adjusted until the shaft root circle diameter d_{f1} according |
| | to the [DIN 5480] is reached. |
| c_{F2} = c_{FP2} | Due to the empirical character of the [DIN 5480], this value has |
| | to be adjusted until the hub root circle diameter d_{f2} according |
| | to the [DIN 5480] is reached. |
| h_{w}(R_{hw} = 0) | 0.9 · m |
| R_{hw} | 0 |
| A_{hw} | / |

Geometry Compatibility to the [DIN 5480]

Although geometry equivalence between splined shaft connections according to (Tab. 2, Tab. 3) as well as according to the [DIN 5480] is possible by considering the contents listed in Tab. 5. However, with reference to [Wild 20], the aim can also be merely to generate compatibility between these profile shapes with further optimal geometric design of the connection partners. Under the aspect of shape stability, this is to be recommended. The above-mentioned requirement is ensured with consideration of the boundary conditions listed in Tab. 6. [Wild 20]

TABLE 6
[Wild 20]

| Symbol | Toothing data and calculation equations |
|---|---|
| d_{B} | Select acc. to the [DIN 5480] |
| A_{dB} | −0.1 · m |
| m | Select acc. to the [DIN 5480] |
| x_{I1} | −0.05 ≤ x_{I1} ≤ 0.45 |
| x_{I2} | −x_{I1} |
| z₁ | Select acc. to the [DIN 5480] |
| z₂ | −z₁ |
| α | 30°, cf. [DIN 5480] |
| h_{w}(R_{hw} = 0) | 0.9 · m |
| R_{hw} | 0 |
| A_{hw} | / |

Requirement-Specific Design

With the inventive system for nominal geometry generation of involute splined shaft connections, cf. (Tab. 2, Tab. 3), unrestricted access to the parameters controlling this profile shape, cf. Tab. 1, is possible within the technically given limits. Thus, the connections originating from it can be fully aligned to the requirements placed on them. In the design examples, the given possibilities for adapting the nominal geometry of involute splined shaft connections according to (Tab. 2, Tab. 3) are visualized. It should be noted that with the available knowledge base, the requirement-specific parameter influences in wide areas can at least be estimated. For the aspect of shape stability, especially [Wild 20] should be referred to. [Wild 20]

Note on Standardization

With regard to the inventive system for nominal geometry generation of involute splined shaft connections, cf. (Tab. 2, Tab. 3), it should be noted that in the context of a potentially normative transition, the definition of preferred values for the input parameters listed in Tab. 1 is useful, for example, to ensure the interchangeability resp. reproducibility of connection partners. However, the making of corresponding conventions or the submission of corresponding proposals is not the subject of the present application, but is a further activity. [Wild 20]

Design Examples

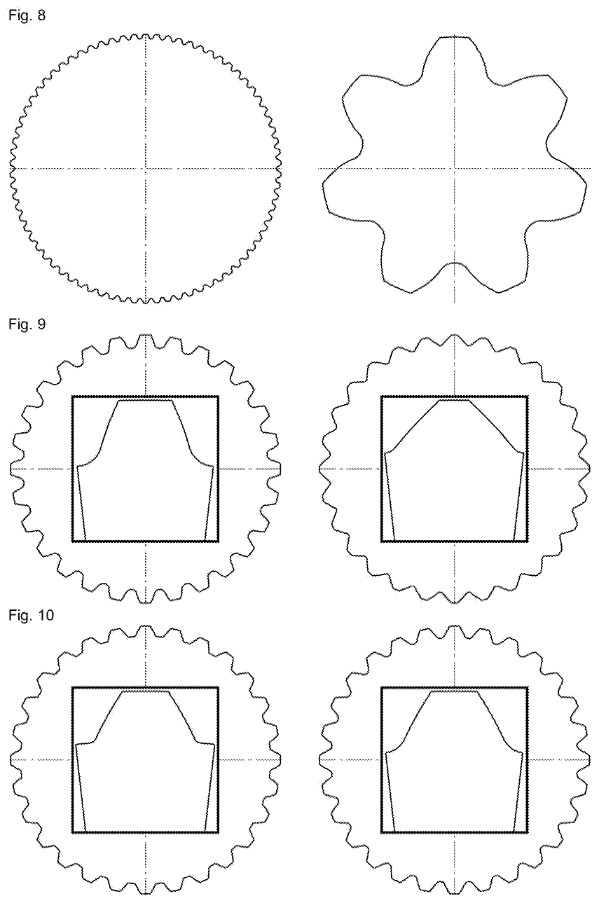

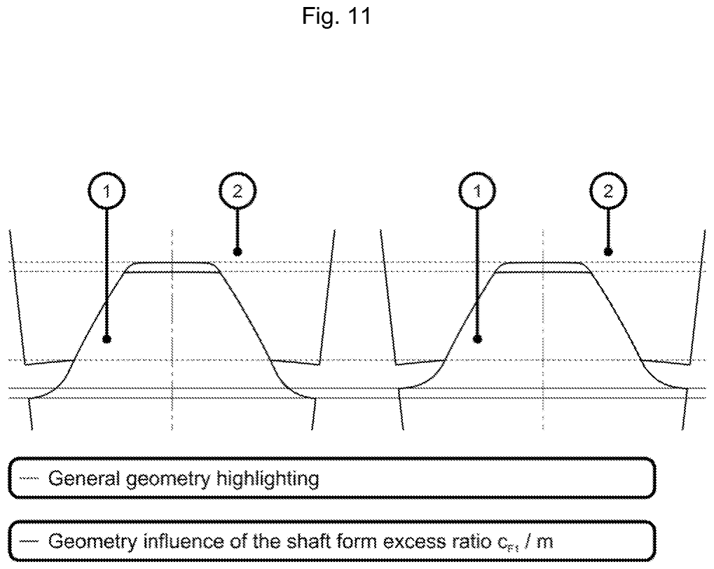

FIG. 7 to FIG. 14 show examples of the possibilities provided by the inventive system for generation of nominal geometry of involute based splined shaft connections, cf. (Tab. 2, Tab. 3), for the requirement-specific design of such connections. [Wild 20]

Symbols, designations and units

| Symbol | Designations | Unit |
|---|---|---|
| A_{dB} | Reference diameter distance | mm |
| A_{hw} | Distribution key of the reduction of | / |
| | the effective contact height | |
| c | Tip clearance | mm |
| c_{F} | Form excess | mm |
| c_{Fmin} | Minimum form excess | mm |
| c_{FP} | Form excess of the reference | mm |
| cₚ | Tip clearance of the reference | mm |
| d | Pitch circle diameter | mm |
| dₐ | Tip circle diameter | mm |
| d_{B} | Reference diameter | mm |
| d_{b} | Base circle diameter | mm |
| d_{E} | Coordinate of the involute in radial direction | mm |
| d_{Ff} | Root form circle diameter | mm |
| d_{f} | Root circle diameter | mm |
| e₂ | Nominal hub tooth gap | mm |
| h_{aP} | Tip height of the reference profile | mm |
| h_{aP0} | Tip height of the tool reference profile | mm |
| h_{fP} | Root height of the reference profile | mm |
| hₚ | Tooth height of the reference profile | mm |
| h_{w} | Effective contact height | mm |
| K | Circle used to generate the root rounding radius | / |
| \vec{K}_{M} | Root circle centre point vector | mm |
| m | Module | mm |
| p | Pitch | mm |
| R_{hw} | Reduction factor of the effective contact height | / |
| s₁ | Nominal tooth thickness | mm |
| u_{E} | Control variable of the involute | / |
| x | Profile shift factor | / |
| x_{I} | Initiation profile shift factor | / |
| x_{M} | Modification profile shift factor | / |
| y | Gen. profile modification factor | / |
| z | Gen. number of teeth | / |
| α | Flank angle | Rad |
| α_{E} | Involute reallocation Angle | Rad |
| α_{Er} | Angle between x-axis and involute on the pitch circle | Rad |
| α_{KM} | Coordinate of the root circle centre | Rad |
| | point in rotational direction | |
| α_{KM}^{V} | Coordinate of the root circle centre in | Rad |
| | rotational direction with | |
| | full rounding | |
| αₛ | Sector angle | Rad |
| αₛ₁ | Shaft tooth thickness angle on the pitch circle | Rad |
| ρ_{f} | Root rounding radius | mm |
| ρ_{f}^{V} | Root rounding radius at full rounding | mm |
| ρ_{fP} | Root rounding radius of the reference profile | mm |
| var. | Varied | / |
| voll. | Fully rounded | / |
| 1 | Shaft | / |
| 2 | Hub | / |
| 3 | Profile reference line | / |

### LITERATURE

[DIN 323] Norm DIN 323, 1974-08-00: Normzahlen und Normreihen

[DIN 3960] Norm DIN 3960, 1987-03-00: Begriffe und Bestimmungsgrößen für Stirnräder (Zylinderräder) und Stirnradpaare (Zylinderradpaare) mit Evolventenverzahnung (Nachfolgedokument: DIN ISO 21771, 2014-08-00

[DIN 5480] Norm DIN 5480, 2006-03-00: Passverzahnungen mit Evolventenflanken und Bezugsdurchmesser

[ISO 4156] Norm ISO 4156, 2005-10-00: Passverzahnungen mit Evolventenflanken. Metrische Module, Flankenzentriert

[DFG ZI 1161] Ziaei, M., Selzer, M.: Entwicklung kontinuierlicher unrunder Innen- und Außenkonturen für formschlüssige Welle-Nabe-Verbindungen und Ermittlung analytischer Lösungsansatze, DFG-Zwischenbericht DFG ZI 1161

[FVA 742 I] Wild, J.; Mörz, F.; Selzer, M.: Optimierung des Zahnwellenprofils primär zur Drehmomentübertragung unter Berücksichtigung wirtschaftlicher Fertigungsmöglichkeiten, FVA-Forschungsvorhaben Nr. 742 I, Frankfurt/Main, 2018 (FVA-Heft 1316)

[Maiw 08] Waiwald, A.: Numerische Untersuchungen von unrunden Profilkonturen für Welle-Nabe-Verbindungen, Diplomarbeit, Westsächsische Hochschule Zwickau, 2008

[Wild 20] Wild, J.: Optimierung der Tragfähigkeit von Zahnwellenverbindungen, Technische Universitat Clausthal, Dissertation, (noch nicht veröffentlicht)

Figure captions

| | |
|---|---|
| 1 | Reference profile according to the [DIN 5480] [Wild 20] |
| 2 | Derivation of the profile shift [Wild 20] |
| 3 | Geometric relationships of involute splined shaft connections according to the |
| | [DIN 5480] in the shaft root area on the example of the connection (Tab. 2, |
| | Tab. 3) − 45 × 1.5 × 28 (α = 30°; ρ_{f1}/m = 0.48; ρ_{f2}/m = 0.16; c_{F1}/m = |
| | 0.12; c_{F2}/m = 0.02; R_{hw} = 0; A_{hw} = /) [Wild 20] |
| 4 | Geometric differences of the profile shaft connections compared in the |
| | research project [FVA 742 I] (same scale) [Wild 20] |
| 5 | Basic systematics of the inventive system for profile generation of involute |
| | splined shaft connections, cf. (Tab. 2, Tab. 3), on the example of the |
| | connection (Tab. 2, Tab. 3) − 45 × 1.5 × 28 (α = 30°; ρ_{f1}/m = 0.48; ρ_{f2}/m = |
| | 0.16; c_{F1}/m = 0.12; c_{F2}/m = 0.02; R_{hw} = 0; A_{hw} = /) [Wild 20] |
| 6 | Adjusted reference profile of the [DIN 5480] [Wild 20] |
| 7 | Requirement-specific design of toothed shaft connections according to (Tab. |
| | 2, Tab. 3) by selecting the reference diameter d_{B} as well as the reference |
| | diameter distance A_{dB} [Wild 20] |
| 8 | Requirement-specific design of toothed shaft connections according to the |
| | inventive system for nominal geometry generation of involute splined shaft |
| | connections, cf. (Tab. 2, Tab. 3), by the selection of the module m resp. the |
| | shaft number of teeth z₁ on the example of the connection (Tab. 2, Tab. |
| | 3) − 45 × 0.6 × 74 (α = 30°; ρ_{f1}/m = 0.48; c_{F1}/m = 0.12; R_{hw} = 0; A_{hw} = /) |
| | left as well as (Tab. 2, Tab. 3) − 45 × 5 × 7 (α = 30°; ρ_{f1}/m = 0.48; c_{F1}/m = |
| | 0.12; R_{hw} = 0; A_{hw} = /) right with shaft focusing (same scale) [Wild 20] |
| 9 | Requirement-specific design of toothed shaft connections according to the |
| | inventive system for nominal geometry generation of involute splined shaft |
| | connections, cf. (Tab. 2, Tab. 3), by the selection of the flank angle α on the |
| | example of the connection (Tab. 2, Tab. 3) − 45 × 1.5 × 28 (α = 20°; ρ_{f1}/m = |
| | 0.56; c_{F1}/m = 0.12; R_{hw} = 0; A_{hw} = /) left as well as (Tab. 2, Tab. |
| | 3) − 45 × 1.5 × 28 (α = 45°; ρ_{f1}/m = 0.24; c_{F1}/m = 0.12; R_{hw} = 0; A_{hw} = /) |
| | right with shaft focusing (same scale) [Wild 20] |
| 10 | Requirement-specific design of toothed shaft connections according to the |
| | inventive system for nominal geometry generation of involute splined shaft |
| | connections, cf. (Tab. 2, Tab. 3), by the selection of the root rounding radii ρ_{f} |
| | on the example of the connection (Tab. 2, Tab. 3) − 45 × 1.5 × 28 (α = 30°; |
| | ρ_{f1}/m = 0.16; c_{F1}/m = 0.12; R_{hw} = 0; A_{hw} = /) left as well as (Tab. 2, Tab. |
| | 3) − 45 × 1.5 × 28 (α = 30°; ρ_{f1}/m = voll.; c_{F1}/m = 0.12; R_{hw} = 0; A_{hw} = /) |
| | right with shaft focusing (same scale) [Wild 20] |
| 11 | Requirement-specific design of toothed shaft connections according to the |
| | inventive system for nominal geometry generation of involute splined shaft |
| | connections, cf. (Tab. 2, Tab. 3), by the selection of the form excesses c_{F} on |
| | the example of the connection (Tab. 2, Tab. 3) − 45 × 1.5 × 28 (α = 30°; |
| | ρ_{f1}/m = 0.48; ρ_{f2}/m = 0.16; c_{F1}/m = 0.12; c_{F2}/m = 0.02; R_{hw} = 0; A_{hw} = /) |
| | left as well as (Tab. 2, Tab. 3) − 45 × 1.5 × 28 (α = 30°; ρ_{f1}/m = 0.48; |
| | ρ_{f2}/m = 0.16; c_{F1}/m = 0.02; c_{F2}/m = 0.02; R_{hw} = 0; A_{hw} = /) right with shaft |
| | focusing (same scale) [Wild 20] |
| 12 | Requirement-specific design of toothed shaft connections according to the |
| | inventive system for nominal geometry generation of involute splined shaft |
| | connections, cf. (Tab. 2, Tab. 3), by the selection of the effective contact |
| | height without profile modification h_{w}(R_{hw} = 0) on the example of the |
| | connection (Tab. 2, Tab. 3) − 45 × 1.5 × 28 (α = 30°; ρ_{f1}/m = 0.48; ρ_{f2}/m = |
| | 0.16; c_{F1}/m = 0.12; c_{F2}/m = 0.02; R_{hw} = 0; A_{hw} = /) with shaft focusing |
| | [Wild 20] |
| 13 | Not profile modified toothed shaft connection (Tab. 2, Tab. 3) − 45 × 1.5 × 28 |
| | (α = 30°; ρ_{f1}/m = 0.48; ρ_{f2}/m = 0.16; c_{F1}/m = 0.12; c_{F2}/m = 0.02; R_{hw} = |
| | 0; A_{hw} = /) (same scale as FIG. 14) [Wild 20] |
| 14 | Requirement-specific design of toothed shaft connections according to the |
| | inventive system for nominal geometry generation of involute splined shaft |
| | connections, cf. (Tab. 2, Tab. 3), by the selection of the profile modification |
| | controlling parameters R_{hw} as well as A_{hw} on the example of the connection |
| | (Tab. 2, Tab. 3) − 45 × 1.5 × 28 (α = 30°; ρ_{f1}/m = 0.48; ρ_{f2}/m = 0.16; |
| | c_{F1}/m − 0.12; c_{F2}/m = 0.02; R_{hw} = var.; A_{hw} = var.) (same scale as FIG. 13) |
| | [Wild 20] |

TABLES

| | |
|---|---|
| 1 | Input parameters of the inventive system for nominal geometry generation of |
| | involute splined shaft connections, cf. (Tab. 2, Tab. 3) [Wild 20] |
| 2 | Inventive system for nominal geometry generation of involute splined shaft |
| | connections [Wild 20] |
| 3 | Inventive system for nominal geometry generation of involute splined shaft |
| | connections (Continuation from Tab. 2) [Wild 20] |
| 4 | Further geometrical parameters not influencing the profile shapes originating |
| | from the inventive system for nominal geometry generation of involute splined |
| | shaft connections, cf. (Tab. 2, Tab. 3) [Wild 20] |
| 5 | Definition of the input parameters listed in Tab. 1 of the inventive system for |
| | nominal geometry generation of involute splined shaft connections, cf. (Tab. |
| | 2, Tab. 3), for geometry equivalence with connections according to the |
| | [DIN 5480] [Wild 20] |
| 6 | Definition of the input parameters listed in Tab. 1 of the inventive system for |
| | nominal geometry generation of involute splined shaft connections, cf. (Tab. |
| | 2, Tab. 3), for geometry compatibility with connections according to the |
| | [DIN 5480] [Wild 20] |

1. Procedure for profile generation of involute splined shaft connection, comprising the steps
a) determination of a circle described by the reference diameter d_{B},
b) distance-based generation of the shaft tip circle using the reference diameter distance A_{dB}, whereby the shaft tip circle represents the quasi first element of the shaft profile,
whereby starting from the shaft tip circle in steps c), d) and e), the shaft profile generation is sequentially unidirectional inward,
c) distance-based generation of the hub tip circle using the effective contact height h_{w},
d) distance-based determination of the contact point between the shaft tooth flank and the shaft root rounding using the shaft form excess of the reference profile c_{FP1} or the shaft form excess c_{F1},
e) generation of the shaft root rounding, whereby in the case of a shaft full rounding, the shaft reference profile is already completely generated with this step,
f) tangential generation of the shaft root circle to the shaft root rounding, whereby this step is only required for partial rounding, and
g) obtain the shaft profile.

2. Procedure according to claim 1, based on the shaft profile furthermore comprising the steps
h) generation of the hub tip circle as the first element of the hub profile, whereby, starting from the shaft tip circle in steps i), j) and k), the hub profile generation is performed sequentially unidirectionally outward,
i) distance-based determination of the contact point between the hub tooth flank and the hub root rounding using the hub form excess of the reference profile c_{FP2} or the hub form excess c_{F2},
j) generation of the hub root rounding, whereby in the case of a hub full rounding, the hub profile is already completely generated with this step,
k) tangential generation of the hub root circle to the hub root rounding, whereby this step is only required for partial rounding, and
l) obtain the hub profile.

3. Procedure according to claim 1, whereby the reference diameter d_{B} is freely selectable.

4. Procedure according to claim 1, whereby the module m is freely selectable.

5. Procedure according to claim 1, whereby the flank angle α is freely selectable.

6. Procedure according to claim 1, whereby
the root rounding radii ρ_{f} are freely selectable and
the form excesses c_{F} are freely selectable.

7. Procedure according to claim 1, whereby the effective contact height without profile modification h_{w}(R_{hw}=0) is freely selectable.

8. System for profile generation of involute splined shaft connections containing a shaft and a hub, comprising
I) the shaft tip circle, which is completely defined by the shaft tip circle diameter dₐ₁ for a given axis-congruent position, which is also valid for the reference profile and the nominal geometry:

| | | |
|---|---|---|
| A_{dB} | input parameter | according |
| | | to invention |
| d_{B} | input parameter | |
| dₐ₁ | d_{B} + 2 · A_{dB} | according |
| | | to invention |

II) the shaft tooth flank, which is an involute, which is defined by its coordinates (x_{E}; y_{E}):

| | |
|---|---|
| m | input parameter |
| z₁ | input parameter |
| α | input parameter |
| u_{E} | control variable |
| d | m · z₁ |
| d_{b} | d · cos α |
| x_{E} | r_{b} (cos u_{E} + u_{E} sin u_{E}) |
| x_{E} | r_{b} (−sin u_{E} + u_{E} cos u_{E}) |

III. the shaft partial rounding comprising
III.1) the shaft root rounding, which in case of tangent continuity between the shaft tooth flank and the shaft root rounding and between the shaft root rounding and the shaft root circle is completely defined by the shaft root rounding radius ρ_{f1}, whereby in case of a shaft partial rounding this is an input parameter,
III.2) the shaft root circle, which is completely defined by the shaft root circle diameter d_{f1} for a predefined axis-congruent position and the required tangent continuity of the shaft root circle with the shaft root rounding:

| | | |
|---|---|---|
| A_{dB} | input parameter | according to |
| | | invention |
| A_{hw} | input parameter | according to |
| | | invention |
| c_{F1} | input parameter | |
| d_{B} | input parameter | |
| h_{w} | input parameter | according to |
| (R_{hw} = 0) | | invention |
| m | input parameter | |
| R_{hw} | input parameter | according to |
| | | invention |
| z₁ | input parameter | |
| α | input parameter | |
| ρ_{f1} | input parameter | |
| d | m · z₁ | |
| x_{I1} · m | $\frac{{d}_{B} - d - {h}_{w} ( {R}_{hw} = 0 ) + 2 \cdot {A}_{dB}}{2}$ | according to invention |
| x_{I2} · m | −x_{I1} · m | according to |
| | | invention |
| x_{M1} · m | A_{hw} · R_{hw} · h_{w}(R_{hw} = 0) | according to |
| | | invention |
| x_{M2} · m | −x_{M1} · m | according to |
| | | invention |
| x₁ · m | (x_{I1} + x_{M1}) · m | according to |
| | | invention |
| x₂ · m | −x₁ · m resp. (x_{I2} + x_{M2}) · m | according to |
| | | invention |
| y₁ · m | R_{hw} · h_{w}(R_{hw} = 0) · (1 − A_{hw}) | according to |
| | | invention |
| y₂ · m | −y₁ · m | according to |
| | | invention |
| dₐ₂ | −d + 2 · x₂ · m + h_{w}(R_{hw} = 0) + 2 · y₂ · m | according to |
| | | invention |
| d_{b} | d · cos α | |
| u_{E1} | $\sqrt{{( \frac{- {r}_{a 2} - {c}_{F 1}}{{r}_{b}} )}^{2} - 1}$ | according to invention |
| \|\vec{K}_{M1}\| | $\sqrt{\begin{matrix}{( {r}_{b} ( cos {u}_{E 1} + {u}_{E 1} sin {u}_{E 1} ) + {ρ}_{f 1} sin {u}_{E 1} )}^{2} + \\ + {( {r}_{b} ( - sin {u}_{E 1} + {u}_{E 1} cos {u}_{E 1} ) + {ρ}_{f 1} cos {u}_{E 1} )}^{2}\end{matrix}}$ | according to invention |
| d_{f1} | 2 · (\|\vec{K}_{M1}\|− ρ_{f1}) | according to |
| | | invention |

IV) the shaft full rounding comprising
IV.1 the shaft root rounding, which in case of tangent continuity between the shaft tooth flank and the shaft root rounding is completely defined by the shaft root rounding radius at full rounding ρ_{f1}^{V}:

| | | |
|---|---|---|
| A_{dB} | input parameter | according to |
| | | invention |
| A_{hw} | input parameter | according to |
| | | invention |
| c_{F1} | input parameter | |
| d_{B} | input parameter | |
| h_{w} | input parameter | according to |
| (R_{hw} = 0) | | invention |
| m | input parameter | |
| R_{hw} | input parameter | according to |
| | | invention |
| z₁ | input parameter | |
| α | input parameter | |
| π | mathematical constant | |
| p | m · π | |
| d | m · z₁ | |
| x_{I1} · m | $\frac{{d}_{B} - d - {h}_{w} ( {R}_{hw} = 0 ) + 2 \cdot {A}_{dB}}{2}$ | according to invention |
| x_{M1} · m | A_{hw} · R_{hw} · h_{w}(R_{hw} = 0) | according to |
| | | invention |
| x₁ · m | (x_{I1} + x_{M1}) · m | according to |
| | | invention |
| s₁ | $\frac{p}{2} + 2 \cdot {x}_{1} \cdot m \cdot tan α$ | |
| αₛ₁ | $\frac{{s}_{1}}{r}$ | according to invention |
| α_{Er} | $\vert {tan}^{- 1} ( \frac{\sqrt{1 - {cos}^{2} α}}{cos α} ) - \frac{\sqrt{1 - {cos}^{2} α}}{cos α} \vert$ | according to invention |
| α_{E} | $\frac{{α}_{s 1}}{2} + {α}_{Er}$ | according to invention |
| α_{S} | $\frac{2 π}{{z}_{1}}$ | according to invention |
| α_{KM1}^{V} | $( - 1 ) \cdot ( {α}_{E} - \frac{{α}_{S}}{2} )$ | according to invention |
| x₂ · m | −x₁ · m resp. (x_{I2} + x_{M2}) · m | according to |
| | | invention |
| y₁ · m | R_{hw} · h_{w}(R_{hw} = 0) · (1 − A_{hw}) | according to |
| | | invention |
| y₂ · m | −y₁ · m | according to |
| | | invention |
| dₐ₂ | −d + 2 · x₂ · m + h_{w}(R_{hw} = 0) + 2 · y₂ · m | according to |
| | | invention |
| d_{b} | d · cos α | |
| u_{E1} | $\sqrt{{( \frac{- {r}_{a 2} - {c}_{F 1}}{{r}_{b}} )}^{2} - 1}$ | according to invention |
| ρ_{f1}^{V} | $\frac{{r}_{b} ( \begin{matrix}tan ( {α}_{KM 1}^{V} ) ( cos {u}_{E 1} + {u}_{E 1} sin {u}_{E 1} ) + \\ + sin {u}_{E 1} - {u}_{E 1} cos {u}_{E 1}\end{matrix} )}{cos {u}_{E 1} - tan ( {α}_{KM 1}^{V} ) sin {u}_{E 1}}$ | according to invention |

IV.2) the shaft root circle, which is not part of the shaft profile shape in case of shaft full rounding, but can nevertheless be calculated and then has the character of a design element, whereby in case of given axis-congruent position as well as the required tangent continuity of the shaft root circle with the shaft root rounding, the shaft root circle is completely defined by the shaft root circle diameter d_{f1}:

| | | |
|---|---|---|
| A_{dB} | input parameter | according to |
| | | invention |
| A_{hw} | input parameter | according to |
| | | invention |
| c_{F1} | input parameter | |
| d_{B} | input parameter | |
| h_{w} | input parameter | according to |
| (R_{hw} = 0) | | invention |
| m | input parameter | |
| R_{hw} | input parameter | according to |
| | | invention |
| z₁ | input parameter | |
| α | input parameter | |
| π | mathematical constant | |
| d | m · z₁ | |
| x_{I1} · m | $\frac{{d}_{B} - d - {h}_{w} ( {R}_{hw} = 0 ) + 2 \cdot {A}_{dB}}{2}$ | according to invention |
| x₁₂ · m | −x_{I1} · m | according to |
| | | invention |
| x_{M1} · m | A_{hw} · R_{hw} · h_{w}(R_{hw} = 0) | according to |
| | | invention |
| x_{M2} · m | −x_{M1} · m | according to |
| | | invention |
| x₁ · m | (x_{I1} + x_{M1}) · m | according to |
| | | invention |
| x₂ · m | −x₁ · m resp. (x_{I2} + x_{M2}) · m | according to |
| | | invention |
| y₁ · m | R_{hw} · h_{w}(R_{hw} = 0) · (1 − A_{hw}) | according to |
| | | invention |
| y₂ · m | −y₁ · m | according to |
| | | invention |
| dₐ₂ | −d + 2 · x₂ · m + h_{w}(R_{hw} = 0) + 2 · y₂ · m | according to |
| | | invention |
| d_{b} | d · cos α | |
| u_{E1} | $\sqrt{{( \frac{- {r}_{a 2} - {c}_{F 1}}{{r}_{b}} )}^{2} - 1}$ | according to invention |
| p | m · π | |
| s₁ | $\frac{p}{2} + 2 \cdot {x}_{1} \cdot m \cdot tan α$ | |
| αₛ₁ | $\frac{{s}_{1}}{r}$ | according to invention |
| α_{Er} | $\vert {tan}^{- 1} ( \frac{\sqrt{1 - {cos}^{2} α}}{cos α} ) - \frac{\sqrt{1 - {cos}^{2} α}}{cos α} \vert$ | according to invention |
| α_{E} | $\frac{{α}_{s 1}}{2} + {α}_{Er}$ | according to invention |
| α_{S} | $\frac{2 π}{{z}_{1}}$ | according to invention |
| α_{KM1}^{V} | $( - 1 ) \cdot ( {α}_{E} - \frac{{α}_{S}}{2} )$ | according to invention |
| ρ_{f1}^{V} | $\frac{{r}_{b} ( \begin{matrix}tan ( {α}_{KM 1}^{V} ) ( cos {u}_{E 1} + {u}_{E 1} sin {u}_{E 1} ) + \\ + sin {u}_{E 1} - {u}_{E 1} cos {u}_{E 1}\end{matrix} )}{cos {u}_{E 1} - tan ( {α}_{KM 1}^{V} ) sin {u}_{E 1}}$ | according to invention |
| \|\vec{K}_{M1}\| | $\sqrt{\begin{matrix}{( {r}_{b} ( cos {u}_{E 1} + {u}_{E 1} sin {u}_{E 1} ) - {ρ}_{f 1}^{V} sin {u}_{E 1} )}^{2} + \\ + {( {r}_{b} ( - sin {u}_{E 1} + {u}_{E 1} cos {u}_{E 1} ) - {ρ}_{f 1}^{V} cos {u}_{E 1} )}^{2}\end{matrix}}$ | according to invention |
| d_{f1} | 2 · (\|\vec{K}_{M1}\| − ρ_{f1}^{V}) | according to |
| | | invention |

V) the hub tip circle, which in case of a predefined axis-congruent position is completely defined by the hub tip circle diameter dₐ₂, which is valid equally for reference profile and nominal geometry:

| | | |
|---|---|---|
| A_{dB} | input parameter | according to |
| | | invention |
| A_{hw} | input parameter | according to |
| | | invention |
| d_{B} | input parameter | |
| h_{w}(R_{hw} = 0) | input parameter | according to |
| | | invention |
| m | input parameter | |
| R_{hw} | input parameter | according to |
| | | invention |
| z₁ | input parameter | |
| d | m · z₁ | |
| x_{I1} · m | $\frac{{d}_{B} - d - {h}_{w} ( {R}_{hw} = 0 ) + 2 \cdot {A}_{dB}}{2}$ | according to invention |
| x_{I2} · m | −x_{I1} · m | according to |
| | | invention |
| x_{M1} · m | A_{hw} · R_{hw} · h_{w}(R_{hw} = 0) | according to |
| | | invention |
| x_{M2} · m | −x_{M1} · m | according to |
| | | invention |
| x₁ · m | (x_{I1} + x_{M1}) · m | according to |
| | | invention |
| x₂ · m | −x₁ · m resp. (x_{I2} + x_{M2}) · m | according to |
| | | invention |
| y₁ · m | R_{hw} · h_{w}(R_{hw} = 0) · (1 − A_{hw}) | according to |
| | | invention |
| y₂ · m | −y₁ · m | according to |
| | | invention |
| dₐ₂ | −d + 2 · x₂ · m + h_{w}(R_{hw} = 0) + 2 · y₂ · m | according to |
| | | invention |

VI) the hub tooth flank, which is an involute, which is defined by its coordinates (x_{E}; y_{E}):

| | |
|---|---|
| m | input parameter |
| z₁ | input parameter |
| α | input parameter |
| u_{E} | control variable |
| d | m · z₁ |
| d_{b} | d · cos α |
| x_{E} | r_{b} (cos u_{E} + u_{E} sin u_{E}) |
| x_{E} | r_{b} (−sin u_{E} + u_{E} cos u_{E}) |

VII) the hub root rounding comprising
VII.1) the hub partial rounding with
VII.1a) the hub root rounding, which in case of tangent continuity between the hub tooth flank and the hub root rounding and between the hub root rounding and the hub root circle is completely defined by the hub root rounding radius ρ_{f2}, whereby in case of a hub partial rounding this is an input parameter
VII.1b) the hub root circle, which is completely defined by the hub root circle diameter d_{f2} for a predefined axis-congruent position and the required tangent continuity of the hub root circle with the hub root rounding:

| | | |
|---|---|---|
| A_{dB} | input parameter | according to |
| | | invention |
| c_{F2} | input parameter | |
| d_{B} | input parameter | |
| m | input parameter | |
| z₁ | input parameter | |
| α | input parameter | |
| ρ_{f2} | input parameter | |
| dₐ₁ | d_{B} + 2 · A_{dB} | according to |
| | | invention |
| d | m · z₁ | |
| d_{b} | d · cos α | |
| u_{E2} | $\sqrt{{( \frac{{r}_{a 1} + {c}_{F 2}}{{r}_{b}} )}^{2} - 1}$ | according to invention |
| \|\vec{K}_{M2}\| | $\sqrt{\begin{matrix}{( {r}_{b} ( cos {u}_{E 2} + {u}_{E 2} sin {u}_{E 2} ) - {ρ}_{f 2} sin {u}_{E 2} )}^{2} + \\ + {( {r}_{b} ( - sin {u}_{E 2} + {u}_{E 2} cos {u}_{E 2} ) - {ρ}_{f 2} cos {u}_{E 2} )}^{2}\end{matrix}}$ | according to invention |
| d_{f2} | (−1) · 2 · (\|\vec{K}_{M2}\| + ρ_{f2}) | according to |
| | | invention |

VII.2) the hub full rounding with
VII.2a) the hub root rounding, which in case of tangent continuity between the hub tooth flank and the hub root rounding is completely defined by the hub root rounding radius at full rounding ρ_{f2}^{V}:

| | | |
|---|---|---|
| A_{dB} | input parameter | according to |
| | | invention |
| A_{hw} | input parameter | according to |
| | | invention |
| c_{F2} | input parameter | |
| d_{B} | input parameter | |
| h_{w}(R_{hw} = 0) | input parameter | according to |
| | | invention |
| m | input parameter | |
| R_{hw} | input parameter | according to |
| | | invention |
| z₁ | input parameter | |
| α | input parameter | |
| π | mathematical constant | |
| p | m · π | |
| d | m · z₁ | |
| x_{I1} · m | $\frac{{d}_{B} - d - {h}_{w} ( {R}_{hw} = 0 ) + 2 \cdot {A}_{dB}}{2}$ | according to invention |
| x_{M1} · m | A_{hw} · R_{hw} · h_{w}(R_{hw} = 0) | according to |
| | | invention |
| x₁ · m | (x_{I1} + x_{M1}) · m | according to |
| | | invention |
| s₁ | $\frac{p}{2} + 2 \cdot {x}_{1} \cdot m \cdot tan α$ | |
| αₛ₁ | $\frac{{s}_{1}}{r}$ | according to invention |
| α_{Er} | $\vert {tan}^{- 1} ( \frac{\sqrt{1 - {cos}^{2} α}}{cos α} ) - \frac{\sqrt{1 - {cos}^{2} α}}{cos α} \vert$ | according to invention |
| α_{E} | $\frac{{α}_{s 1}}{2} + {α}_{Er}$ | according to invention |
| α_{KM2}^{V} | (−1) · α_{E} | according to |
| | | invention |
| dₐ₁ | d_{B} + 2 · A_{dB} | according to |
| | | invention |
| d_{b} | d · cos α | |
| u_{E2} | $\sqrt{{( \frac{{r}_{a 1} + {c}_{F 2}}{{r}_{b}} )}^{2} - 1}$ | according to invention |
| ρ_{f2}^{V} | $\frac{{r}_{b} ( \begin{matrix}tan ( {α}_{KM 2}^{V} ) ( cos {u}_{E 2} + {u}_{E 2} sin {u}_{E 2} ) + \\ + sin {u}_{E 2} - {u}_{E 2} cos {u}_{E 2}\end{matrix} )}{tan ( {α}_{KM 2}^{V} ) sin {u}_{E 2} - cos {u}_{E 2}}$ | according to invention |

VII.2b) the hub root circle, which is not part of the hub profile shape in case of hub full rounding, but can nevertheless be calculated and then has the character of a design element, whereby in case of a given axis-congruent position as well as the required tangent continuity of the hub root circle with the hub root rounding, the hub root circle is completely defined by the hub root circle diameter d_{f2}:

| | | |
|---|---|---|
| A_{dB} | input parameter | according to |
| | | invention |
| A_{hw} | input parameter | according to |
| | | invention |
| c_{F2} | input parameter | |
| d_{B} | input parameter | |
| h_{w}(R_{hw} = 0) | input parameter | according to |
| | | invention |
| R_{hw} | input parameter | according to |
| | | invention |
| m | input parameter | |
| z₁ | input parameter | |
| α | input parameter | |
| π | mathematical constant | |
| p | m · π | |
| d | m · z₁ | |
| x_{I1} · m | $\frac{{d}_{B} - d - {h}_{w} ( {R}_{hw} = 0 ) + 2 \cdot {A}_{dB}}{2}$ | according to invention |
| x_{M1} · m | A_{hw} · R_{hw} · h_{w}(R_{hw} = 0) | according to |
| | | invention |
| x₁ · m | (x_{I1} + x_{M1}) · m | according to |
| | | invention |
| s₁ | $\frac{p}{2} + 2 \cdot {x}_{1} \cdot m \cdot tan α$ | |
| αₛ₁ | $\frac{{s}_{1}}{r}$ | according to invention |
| α_{Er} | $\vert {tan}^{- 1} ( \frac{\sqrt{1 - {cos}^{2} α}}{cos α} ) - \frac{\sqrt{1 - {cos}^{2} α}}{cos α} \vert$ | according to invention |
| α_{E} | $\frac{{α}_{s 1}}{2} + {α}_{Er}$ | according to invention |
| α_{KM2}^{V} | (−1) · α_{E} | according to |
| | | invention |
| dₐ₁ | d_{B} + 2 · A_{dB} | according to |
| | | invention |
| d_{b} | d · cos α | |
| u_{E2} | $\sqrt{{( \frac{{r}_{a 1} + {c}_{F 2}}{{r}_{b}} )}^{2} - 1}$ | according to invention |
| ρ_{f2}^{V} | $\frac{{r}_{b} ( \begin{matrix}tan ( {α}_{KM 2}^{V} ) ( cos {u}_{E 2} + {u}_{E 2} sin {u}_{E 2} ) + \\ + sin {u}_{E 2} - {u}_{E 2} cos {u}_{E 2}\end{matrix} )}{tan ( {α}_{KM 2}^{V} ) sin {u}_{E 2} - cos {u}_{E 2}}$ | according to invention |
| \|\vec{K}_{M2}\| | $\sqrt{\begin{matrix}{( {r}_{b} ( cos {u}_{E 2} + {u}_{E 2} sin {u}_{E 2} ) - {ρ}_{f 2}^{V} sin {u}_{E 2} )}^{2} + \\ + {( {r}_{b} ( - sin {u}_{E 2} + {u}_{E 2} cos {u}_{E 2} ) - {ρ}_{f 2}^{V} cos {u}_{E 2} )}^{2}\end{matrix}}$ | according to invention |
| d_{f2} | (−1) · 2 · (\|\vec{K}_{M2}\|+ ρ_{f2}^{V}) | according to |
| | | invention |

9. Parameter reference diameter distance A_{dB}, with which the function for free selection of the distance between the reference diameter d_{B} and the shaft tip diameter dₐ₁ is implemented in the system according to claim 8.

10. Use of the system according to claim 8 for profile modification, whereby the parameters referred to as x_{I1}, x_{I2}, previously x₁, x₂, are known, while the profile modification is based on the factors x_{M1}, x_{M2}, y₁, y₂, R_{hw}, A_{hw} and functionally interacts with the previously designated parameters of the profile shift.
